(19) United States
(12) Patent Application Publication
(10) Pub. No.: US 2024/0233037 A1
(43) Pub. Date: Jul. 11, 2024

(54) SERVER AND METHOD FOR ACCOUNTING FRAUD DETECTION, AND RECORDING MEDIUM ON WHICH COMMAND IS RECORDED

(71) Applicant: Yeo-Eul YOON, Seoul (KR)

(72) Inventors: Chul JUNG, Seoul (KR); Han Seop SHIN, Seoul (KR)

(73) Assignee: Yeo-Eul YOON, Seoul (KR)

(21) Appl. No.: 18/289,493

(22) PCT Filed: May 4, 2022
(86) PCT No.: PCT/KR2022/006377

§ 371 Date: Nov. 3, 2023

(30) Foreign Application Priority Data
May 7, 2021 (KR) 10-2021-0059276

(51) Int. Cl. G06Q 40/12

(52) U.S. Cl. CPC G06Q 40/12

(57) ABSTRACT

The present disclosure proposes a server for detecting accounting fraud. The server according to the present disclosure may collect data from a server of a company to be audited, generate result data by applying a plurality of analyzing functions corresponding to a plurality of accounting fraud patterns, respectively, to the collected data regarding the plurality of statements, determine, on the basis of the result data, that a pattern shown in one or more statements from among the plurality of statements matches one accounting fraud pattern, determine a risk class of a potential accounting fraud indicated by the one or more statements, and generate a warning against potential accounting fraud in response to the determination of the risk class.

### TECHNICAL FIELD

The present disclosure relates to accounting fraud detection and, more specifically, to constant checking and reporting of accounting fraud.

### BACKGROUND

Accounting audit is a term commonly used to refer to financial statement audits performed by independent auditors such as accounting firms. Financial statements indicate systematic presentations of historical financial information intended to communicate, according to a specified financial reporting system, the status of an entity's economic resources or obligations at a certain time, or changes in the same over a period of time. Financial statement audits aim to improve the level of trust of users of financial statements. To this end, an auditor obtains reasonable assurance as to whether or not the financial statements are generally free from material misstatement as a result of fraud or errors and expresses an opinion on whether or not the financial statements have been prepared in accordance with applicable financial reporting frameworks in all material respect (for example, an opinion that “the financial statement is presented fairly in all material respects in accordance with the applicable financial reporting framework”). As described above, the primary purpose of modern accounting auditing is to determine whether or not the overall financial statements are appropriate, rather than to detect accounting fraud.

In addition, the evidence supporting financial statements may be very extensive. For example, the statements recording company's transactions may be hundreds of thousands cases or more per month depending on the size of the company. A lot of manpower and time may be required to review such evidence, which may result in problems with the efficiency and cost of the audit.

Accordingly, modern accounting audit focuses on minimizing the scope of evidence review while maintaining audit quality through analysis of financial statements under the premise that not all evidence such as statements can be reviewed. From this point of view, some processes of accounting audit are performed in a manner (so-called a top-down method) of analyzing the financial statement (for example, through the process of analyzing changes in financial data within a period), selecting account titles with a high probability of accounting fraud, and reviewing only limited evidence related to the corresponding accounting titles. For example, as shown in Table 1 below, if there is no change in sales for the current period (current fiscal year) compared to the previous period (previous fiscal year), but if a change rate of accounts receivable reaches 50%, it may be determined that the possibility of accounting fraud in relation to the account title of accounts receivable is high, and it may be identified whether or not there was accounting fraud by reviewing the relevant evidence in a necessary range.

TABLE 1

| | Current period | Previous period | Changes | Change rates |
|---|---|---|---|---|
| Sales | 100 | 100 | 0 | 0% |
| Accounts | 150 | 100 | 50 | 50% |
| receivable | | | | |

However, there are various types of accounting frauds that are virtually impossible to detect by the conventional top-down accounting audit (for example, when financial information is manipulated such that abnormalities cannot be detected by normal analytical procedures). In addition, since existing accounting audits are limited to analyzing and evaluating financial statements that have been closed at a specific time at regular intervals, such as annually or quarterly, even if accounting fraud is detected through accounting audits, the time for appropriately dealing with it may have been missed.

### SUMMARY

The present disclosure is to solve the problems of the prior art described above and provides a technique for detecting accounting fraud.

According to an aspect of the present disclosure, a server for detecting accounting fraud may be proposed. A server according to an aspect of the present disclosure may include a transceiver, one or more processors, and one or more memories storing instructions that cause, when executed by the one or more processors, the one or more processors to perform operations. The operations may include operations of collecting data including data regarding a plurality of statements of a company to be audited, data regarding one or more customers of the company to be audited, and data regarding personnel records of the company to be audited from an external device through the transceiver, applying the data regarding the plurality of statements to each of a plurality of analyzing functions corresponding to a plurality of accounting fraud patterns to generate result data for each of a plurality of analyzing functions, determining that a pattern shown in one or more statements among the plurality of statements matches one accounting fraud pattern among the plurality of accounting fraud patterns based on the result data, in response to determining that the pattern shown in the one or more statements matches the one accounting fraud pattern, determining a risk class of potential accounting fraud represented by the one or more statements, based at least in part on the data regarding one or more customers and the data regarding personnel records, and generating a warning against the potential accounting fraud in response to determination of the risk class.

According to an embodiment, the one or more processors may be configured to repeatedly perform the collecting operation in a preset cycle, and the data regarding the plurality of statements may include data regarding all statements input to the external device within a preset period of time based on each collection time.

According to an embodiment, the operations may further include operations of comparing data regarding the plurality of statements of the company to be audited collected at a first collection time with data regarding the plurality of statements of the company to be audited collected at a second collection time, which is immediately one cycle after the first collection time, to determine that at least a part of the data regarding the plurality of statements of the company to be audited has been modified between the first collection time and the second collection time and, in response to determining that at least a part of the data regarding the plurality of statements of the company to be audited has been modified between the first collection time and the second collection time, generating a warning against potential accounting fraud according to the modification.

According to an embodiment, the operation of generating the result data may include an operation of applying the data regarding the plurality of statements to each of the plurality of analyzing functions in cycles preset for the respective analyzing functions.

According to an embodiment, the operations may further include an operation of pre-processing the collected data. The pre-processing operation may include operations of normalizing the collected data to conform to a preset database format, normalizing a customer name among the data regarding one or more customers according to a preset rule, and grouping account titles among the data regarding the plurality of statements.

According to an embodiment, the analyzing function corresponding to the one accounting fraud pattern may be configured to determine, for one statement, a case to be true if an account title on the debit side is account payable, an account title on the credit side is advance payment, and a customer name on the debit side is different from a customer name on the credit side.

According to an embodiment, the plurality of analyzing functions may include one or more analyzing functions of a first type, which are configured to determine, for one statement, a case to be true if an account title on the debit side and an account title on the credit side respectively satisfy preset criteria and one or more pieces of information recorded in the statement satisfy preset criteria, one or more analyzing functions of a second type, which are configured to determine, for each of two or more statements, a case to be true if an account title on the debit side and an account title on the credit side respectively satisfy preset criteria and one or more pieces of information recorded in the statement satisfy preset criteria, one or more analyzing functions of a third type, which are configured to determine, for a statement whose posting date satisfies preset criteria, a case to be true if an account title on the debit side and an account title on the credit side respectively satisfy preset criteria and one or more pieces of information recorded in the statement satisfy preset criteria, and one or more analyzing functions of a fourth type, which are configured to determine a case to be true if a balance of a designated account title does not meet preset criteria for a preset period of time.

According to an embodiment, the operation of determining the risk class of potential accounting fraud represented by the one or more statements, based at least in part on the data regarding one or more customers and the data regarding personnel records, may include operations of determining a risk class according to a basic risk level of a matching accounting fraud pattern, downgrading the risk class if one of exceptional conditions preset for the company to be audited is satisfied, upgrading the risk class if the data regarding a customer included in the one or more statements satisfies a preset condition for a paper company, upgrading the risk class if a customer's account holder name included in the one or more statements is not a name of the customer or a representative name thereof, upgrading the risk class if the data regarding a customer included in the one or more statements at least partially matches the data regarding personnel records, upgrading the risk class if the data regarding a customer included in the one or more statements is at least partially inconsistent with the data regarding a customer inquired to a credit rating agency, based on a business registration number of the customer, and upgrading the risk class if a customer included in the one or more statements is newly registered in the external device within a preset period of time.

According to an embodiment, the operations may further include operations of generating a report indicating one or more warnings against potential accounting fraud, wherein the one or more warnings occur within a preset period of time and wherein the report includes, for each of the one or more warnings, a matching accounting fraud pattern, a risk class, and data regarding one or more related statements, and transmitting the report to one or more user terminals.

According to an aspect of the present disclosure, a method for detecting accounting fraud may be proposed. A method according to an aspect of the present disclosure may be performed by a server. A method according to an aspect of the present disclosure may include collecting data including data regarding a plurality of statements of a company to be audited, data regarding one or more customers of the company to be audited, and data regarding personnel records of the company to be audited from an external device through a transceiver of the server, applying the data regarding the plurality of statements to each of a plurality of analyzing functions corresponding to a plurality of accounting fraud patterns to generate result data for each of the plurality of analyzing functions, determining that a pattern shown in one or more statements among the plurality of statements matches one accounting fraud pattern among the plurality of accounting fraud patterns based on the result data, determining, in response to determining that the pattern shown in the one or more statements matches the one accounting fraud pattern, a risk class of potential accounting fraud represented by the one or more statements, based at least in part on the data regarding one or more customers and the data regarding personnel records, and generating a warning against the potential accounting fraud in response to determination of the risk class.

According to an aspect of the present disclosure, one or more non-transitory computer-readable recording media storing commands for detecting accounting fraud may be proposed. The commands stored in the recording media according to an aspect of the present disclosure may cause, when executed by one or more processors of a server for detecting accounting fraud, the one or more processors to perform operations. The operations may include collecting data including data regarding a plurality of statements of a company to be audited, data regarding one or more customers of the company to be audited, and data regarding personnel records of the company to be audited from an external device through a transceiver of the server, applying the data regarding the plurality of statements to each of a plurality of analyzing functions corresponding to a plurality of accounting fraud patterns to generate result data for each of the plurality of analyzing functions, determining that a pattern shown in one or more statements among the plurality of statements matches one accounting fraud pattern among the plurality of accounting fraud patterns based on the result data, determining, in response to determining that the pattern shown in the one or more statements matches the one accounting fraud pattern, a risk class of potential accounting fraud represented by the one or more statements, based at least in part on the data regarding one or more customers and the data regarding personnel records, and generating a warning against the potential accounting fraud in response to determination of the risk class.

According to various embodiments of the present disclosure, it is possible to detect accounting fraud that is highly likely to be overlooked in the existing top-down method of accounting audits.

According to various embodiments of the present disclosure, it is possible to detect accounting fraud in time.

### BRIEF DESCRIPTION OF DRAWINGS

FIG. 1 is a diagram illustrating an exemplary configuration of a system for accounting fraud detection including a server 100 for accounting fraud detection, a server 110 of a company to be audited, and a user terminal 130 of an auditor 120 according to an embodiment of the present disclosure.

FIG. 2 is a diagram illustrating an exemplary display screen 200 of the user terminal 130 that receives and displays an accounting fraud report according to an embodiment of the present disclosure.

FIG. 3 is a block diagram of the server 100 according to various embodiments of the present disclosure.

FIG. 4 is a diagram illustrating an embodiment of a method of detecting accounting fraud that may be performed by the server 100 according to the present disclosure.

### DETAILED DESCRIPTION

Various embodiments described in this document are illustrated for clearly describing the technical spirit of the present disclosure and are not intended to limit the same to specific embodiments. The technical spirit of the present disclosure includes various modifications, equivalents, and alternatives of each embodiment described in this document, and embodiments selectively combined from all or some of the respective embodiments. In addition, the scope of the technical spirit of the present disclosure is not limited to various embodiments or specific descriptions thereof presented below.

All terms, including technical or scientific terms, used herein may have meanings that are generally understood by a person having ordinary knowledge in the art to which the present disclosure pertains, unless otherwise specified.

Expressions such as “include,” “may include,” “is provided,” “may be provided,” “have,” “may have,” and the like used herein indicate that corresponding features (e.g., functions, operations, components, and the like) exist and do not preclude existence of other features. That is, such expressions should be understood as open-ended terms connoting the possibility of inclusion of other embodiments.

A singular expression used herein may include meanings of plurality, unless otherwise mentioned, and the same is applied to a singular expression recited in the claims.

The terms “first,” “second,” etc. used herein are used to distinguish a plurality of components from one another, unless the context indicates otherwise, and are not intended to limit the order or importance of the relevant components.

Expressions such as “A, B, and C,” “A, B, or C,” “A, B, and/or C,” “at least one of A, B, and C,” “at least one of A, B, or C,” “at least one of A, B, and/or C,” or the like used herein may indicate respective listed items or all possible combinations of the listed items. For example, “at least one of A or B” may refer to (1) at least one A, (2) at least one B, and (3) both at least one A and at least one B.

The expression “based on” used herein is used to describe one or more factors that influence a decision, an action of judgment or an operation described in a phrase or sentence including the relevant expression, and this expression does not preclude an additional factor influencing the decision, the action of judgment or the operation.

As used in this document, when a certain component (e.g., a first component) is described as being “coupled to” or “connected to” another component (e.g., a second component), this should be understood as meaning that the certain component may be coupled or connected directly to the other component or that the certain component may be coupled or connected to the other component via a new intervening component (e.g., a third component).

The expression “configured to” as used in this document may indicate “set to,” “having the ability to,” “modified to,” “made to,” “capable of,” and the like depending on the context. The expression is not limited to the meaning of “specially designed in hardware,” and for example, a processor configured to perform a specific operation may indicate a general-purpose processor capable of performing the specific operation by executing software.

Hereinafter, various embodiments of the present disclosure will be described with reference to the accompanying drawings. In the accompanying drawings and description of the drawings, like or substantially equivalent components may be indicated by like reference numerals. In addition, in the following description of various embodiments, repeated descriptions of identical or relevant components will be omitted, but this does not indicate that such a component is excluded from the embodiment

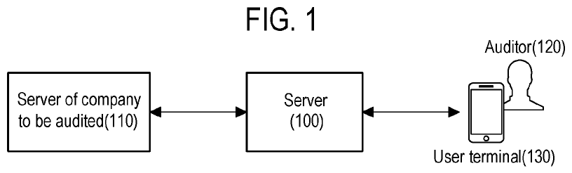

FIG. 1 is a diagram illustrating an exemplary configuration of a system for accounting fraud detection including a server 100 for accounting fraud detection, a server 110 of a company to be audited, and a user terminal 130 of an auditor 120 according to an embodiment of the present disclosure. Each of the server 100, the server 110 of the company to be audited, and the user terminal 130, which are implemented according to various embodiments of the present disclosure, may perform operations to support accounting fraud detection according to the present disclosure. Although only one server of a company to be audited and one user terminal are illustrated in the drawing, it should be understood that any number of servers of the company to be audited and any number of user terminals may constitute a system to support accounting fraud detection.

The server 110 of the company to be audited may obtain data for accounting fraud detection. For example, one or more persons in charge of the company to be audited may input data into the server 110 of the company to be audited using one or more arbitrary programs (e.g., an enterprise resource planning program, an accounting management program, a human resources management program, a customer management program, etc. provided by any manufacturer). Such data input may be part of normal business activities of the company to be audited. In addition, this data input may be made from time to time according to the normal management activities of the company to be audited.

Data for accounting fraud detection may include data regarding statements. A statement refers to an indicator of a certain form for conveying accounting transactions to others and preserving the same as evidence on the books later. In principle, all transactions of the company should be recorded as statements, and the statements become the basic data of the accounting ledger. Although the form of the statement is not uniform, a statement number, customer name, document date, posting date (the date recorded in the accounting ledger), debit amount, credit amount, account title, brief, etc. are usually recorded in the statement. As described above, depending on the size of the company, hundreds of thousands or more statements may be made per month (for example, a KOSPI-listed company with sales of 1.5 trillion KRW as of 2020 has issued about 100,000 statements per month).

Data for accounting fraud detection may include data regarding a customer. The data regarding a customer may include any data maintained by the company to be audited to manage customers. In an embodiment, the data regarding a customer may include data regarding customer names, business registration numbers, account numbers, representative names, contact information, business locations, and the like.

The data for accounting fraud detection may include data regarding personnel records. The data regarding personnel records may include any data maintained by the company to be audited to manage current or retired executives and employees. In an embodiment, the data regarding personnel records may include data regarding names, dates of birth, contact information, addresses, accounts, and the like of current or retired executives and employees.

The server 110 of the company to be audited may store obtained data in an internal storage or external storage and perform necessary processing to provide the stored data to the server 100 according to a request of the server 100.

The server 100 may collect data for accounting fraud detection from the server 110 of the company to be audited. Data collection from the server 110 of the company to be audited may be performed in any possible manner (e.g., the server 100 sends a data request in a certain format to the server 110 of the company to be audited and receives the data itself or an access address to the data from the server 110 of the company to be audited in response thereto).

In an embodiment, the server 100 may collect data from the server 110 of the company to be audited including data regarding a plurality of statements of the company to be audited, data regarding one or more customers of the company to be audited, and data regarding personnel records of the company to be audited. The data regarding a plurality of statements may include data regarding all statements input to the server 110 of the company to be audited within a configured period of time. For example, in the case of applying the accounting fraud detection technology according to an embodiment of the present disclosure to a specific company for the first time (e.g., when a comprehensive audit is performed for the first time after acquiring the company), data regarding all statements written by the company for the past 5 years may be collected. One or more customers may be all or some of the customers registered on the server 110 of the company to be audited at the time of collection. For example, only data regarding a customer related to the statements to be collected may be collected. The personnel records may be all or some of the personnel records entered in the server 110 of the company to be audited at the time of collection.

In an embodiment, the server 100 may repeatedly collect the data for accounting fraud detection from the server 110 of the company to be audited in a preset cycle. Statements collected in every cycle may be all statements input to the server 110 of the company to be audited within a preset period of time based on the time of collection. For example, the server 100 may repeatedly collect daily (e.g., every day), from the server 110 of the company to be audited, data regarding all statements input to the server 110 of the company to be audited within 60 days from the date of collection, data regarding all or some of the customers registered in the server 110 of the company to be audited at the time of collection, or data regarding all or some of personnel records input to the server 110 of the company to be audited at the time of collection. In this way, by collecting data in a range overlapping that in the previous period at every cycle, it is possible to detect the fact that a statement has been modified after being input to the server 110 of the company to be audited. Modification of a statement after being input may indicate potential accounting fraud.

In an embodiment, the server 100 may pre-process the collected data. In an embodiment, as pre-processing of the collected data, the server 100 may normalize the collected data to conform to a preset database format. Since the format of data for accounting fraud detection may be different depending on the company to be audited or depending on the program that the company to be audited uses for input, normalizing data of the company to be audited to conform to a preset database format may facilitate processing data and detecting accounting fraud in a consistent and automated manner for multiple companies to be audited. For example, normalizing the collected data to conform to a preset database format may include unifying notation formats such as date, contact information, account number, business registration number, etc., removing unnecessary spaces or data, processing absence of data for specific items (null processing), and the like.

In an embodiment, as pre-processing of the collected data, the server 100 may normalize a customer name among the customer data according to a preset rule. There are cases in which customers whose customer names are recorded differently in the collected data may be regarded as substantially the same customer from the viewpoint of accounting fraud detection (for example, the case where branches or sales offices of one corporation are represented in different customer names from each other, the case where the notation of “Co., Ltd.” is written differently from each other, or the like). For example, customer names such as “XX Electronics (Division A),” “XX Electronics (Division B),” “XX Electronics Company,” and “XX Electronics Co., Ltd.” may all be normalized to “XX Electronics.” Normalizing customer names according to preset rules described above may prevent substantially the same customer from being recognized as different customers, thereby avoiding false detection as an accounting fraud pattern.

In an embodiment, as pre-processing of the collected data, the server 100 may group account titles among the data for statements. Different account titles may be used for substantially the same account from the viewpoint of accounting fraud detection depending on the company to be audited or depending on the program that the company to be audited uses for input. For example, account titles such as “accounts payable-general,” “accounts payable,” “domestic accounts payable,” and the like may be grouped into “accounts payable,” and “advance payments-contract,” “advance payments (others),” “advance payments (auto insurance premiums),” and the like may be grouped into “advance payments.”

Based on the collected data, the server 100 may determine that a pattern shown in one or more statements matches a preset accounting fraud pattern. In an embodiment, for the above determination, the server 100 may apply data regarding a plurality of statements among the collected data to an analyzing function corresponding to an accounting fraud pattern. If a result of applying one or more of the plurality of statements to the analyzing functions is true, the server 100 may determine that the pattern shown in the statement matches the accounting fraud pattern. Table 2 is a table schematically showing key information of exemplary statements representing an exemplary accounting fraud pattern. The example in Table 2 shows a result of a person in charge of a company to be audited (hereinafter referred to as an “embezzler”) embezzling 1 million KRW in cash and manipulating accounting records to cover up the embezzlement.

TABLE 2

| Statement | | |
|---|---|---|
| number | Debit side | Credit side |
| 1 | Advance payment (customer | Cash 1 million KRW |
| | A) 1 million KRW | |
| 2 | Purchase 2 million KRW | Account payable (customer |
| | | B) 2 million KRW |
| 3 | Account payable (customer | Advance payment (customer |
| | B) 1 million KRW | A) 1 million KRW |

In the example of Table 2, the embezzler pays 1 million KRW in cash to customer A under collusion with customer A, and then receives back all or some of the cash paid to customer A for embezzlement. Normally, the company's cash reserves are strictly checked at short intervals, so it is virtually impossible to embezzle cash without writing a statement about cash reduction. To cover up the reduction in cash due to the embezzlement, the embezzler records 1 million KRW as an advance payment to customer A (statement number 1). It may be possible for the embezzler to enter the advance payment alone without registration of customer A as a purchasing company or actual purchase thereof. Although the embezzler avoids immediate suspicion due to the decrease in cash through this statement record, if the advance payment of 1 million KRW to customer A remains until a later audit, and if the auditor has suspicion about such advance payment, the embezzlement will be likely to be detected. Accordingly, the embezzler manipulates the statement about the normal purchase transaction from customer B. In other words, even though there is actually a purchase of 1 million KRW from customer B, the embezzler overestimates the account payable at 2 million KRW and writes the same on the statement (statement number 2). Subsequently, the embezzler issues a statement to set off 1 million KRW of the account payable to customer B with the 1 million KRW of the advance payment to customer A (statement number 3).

Since the advance payment to customer A may become 0 KRW through a series of accounting record manipulations described above, abnormality cannot be detected by financial statement analysis in a normal accounting audit, and accordingly, the statement may not be reviewed, so that the embezzlement may not be detected. On the other hand, by not following the conventional top-down method of reviewing related statements only when an abnormality is detected, the server 100 for detecting accounting fraud according to an embodiment of the present disclosure can find accounting fraud patterns at any time for all statements within a certain period of time, thereby detecting the accounting fraud as shown in Table 2.

In an embodiment, the analyzing function corresponding to the accounting fraud pattern as shown in Table 2 may be determining, for one statement, a case to be true if the account title on the debit side is account payable, the account title on the credit side is advance payment, and the customer name on the debit side is different from the customer name on the credit side (for example, determining statement number 3 in Table 2 to be true).

In an embodiment, a plurality of accounting fraud patterns and a plurality of analyzing functions corresponding thereto may be preset in the server 100. In this case, the server 100 may respectively apply data regarding a plurality of statements to the plurality of analyzing functions to generate result data of the respective analyzing functions and determine, based on the result data, that a pattern shown in one or more statements matches one accounting fraud pattern among the plurality of accounting fraud patterns. In an embodiment, the server 100 may apply data regarding a plurality of statements to the respective analyzing functions in preset cycles set for the respective analyzing functions. The application cycle of each analyzing function may be set according to the property of a corresponding accounting fraud pattern. Table 3 is a table showing exemplary application cycles of the analyzing functions.

TABLE 3

| Accounting fraud | Application cycles of |
|---|---|
| pattern number | analyzing functions |
| 1 | Daily |
| 2 | Monthly |
| 3 | Quarterly |
| 4 | Daily |
| . . . | . . . |
| N | Daily |

In an embodiment, each analyzing function preset in the server 100 may belong to one of a plurality of types. The plurality of types may include a first type of determining, for one statement, a case to be true if the account title on the debit side and the account title on the credit side respectively satisfy preset criteria and one or more pieces of information recorded in the statement satisfy preset criteria, a second type of determining, for each of two or more statements, a case to be true if the account title on the debit side and the account title on the credit side respectively satisfy preset criteria and one or more pieces of information recorded in the statement satisfy preset criteria, a third type of determining, for a statement whose posting date satisfies preset criteria, a case to be true if the account title on the debit side and the account title on the credit side respectively satisfy preset criteria and one or more pieces of information recorded in the statement satisfy preset criteria, and a fourth type of determining a case to be true if the balance of a designated account title does not meet preset criteria for a preset period.

In response to determining that a pattern shown in one or more statements matches a preset accounting fraud pattern, the server 100 may determine a risk class of potential accounting fraud represented by the one or more statements. The risk class of potential accounting fraud may be determined based at least in part on the data regarding a customer and the data regarding personnel records.

In an embodiment, the server 100 may inquire the basic risk level of the matching accounting fraud pattern and determine a risk class according to the basic risk level. In an embodiment, the server 100 may upgrade or downgrade the risk class according to preset criteria. For example, as the risk class becomes higher (is upgraded), it may indicate a higher likelihood that potential accounting fraud is actual accounting fraud and/or indicate a higher risk of potential accounting fraud.

In an embodiment, if one of exceptional conditions preset for the company to be audited is satisfied (e.g., in the case of a statement about a customer in a special relationship or in the case of a statement about a small amount less than a certain amount), the server 100 may downgrade the risk class.

In an embodiment, the server 100 may upgrade a risk class if data regarding a customer included in one or more statements satisfies a preset condition for a paper company. For example, the server 100 may search for information such as the number of national pension subscribers, the number of employment insurance subscribers, whether or not the business is suspended or closed, and the like using the customer name and business registration number and determine, based on the search result and preset conditions, that there is a high possibility that the customer may be a paper company.

In an embodiment, the server 100 may upgrade the risk class if the customer's account holder name included in one or more statements is not the customer name or the representative name thereof. For example, the server 100 may perform an inquiry about the real name of the customer's account and compare a result thereof with the data regarding a customer.

In an embodiment, if the data regarding a customer included in one or more statements at least partially matches the data regarding personnel records (e.g., the phone number, account number, name, address, etc. match), the server 100 may upgrade the risk class. The matching as above may suggest that the executives and employees of the company to be audited or their families have a special relationship with the customer.

In an embodiment, if the data regarding a customer included in one or more statements is at least partially inconsistent with the data regarding a customer inquired to the credit rating agency based on the business registration number of the customer, the server 100 may upgrade the risk class.

In an embodiment, the server 100 may upgrade the risk class if a customer included in one or more statements is newly registered in a server of the audited institution within a preset period of time.

The server 100 may generate a warning against potential accounting fraud in response to the determination of the risk class. In an embodiment, the server 100 may store the generated warning in a preset form in an internal or external storage. In an embodiment, the server 100 may generate a report indicating one or more warnings for potential accounting fraud. The one or more warnings indicated by the report may include all or some of all warnings about potential accounting fraud that occurred in one or more companies to be audited within a preset period of time. The report may include, for each of the one or more warnings, a matching accounting fraud pattern, a risk class, and data regarding associated one or more statements. In an embodiment, the server 100 may transmit the generated report to one or more user terminals including the user terminal 130. For example, the server 100 may transmit an e-mail containing the generated report to an e-mail account that may be viewed by the user terminal 130. In an embodiment, the server 100 may generate a report in one or more preset cycles and transmit the same to one or more user terminals including the user terminal 130. For example, the server 100 may generate a report according to a set period, for example, daily, monthly, quarterly, and yearly.

In the present disclosure, the user terminal 130 may be any one of various types of devices that the auditor 130 may use for accounting fraud detection. For example, the user terminal 130 may be a portable communication device (e.g., a smartphone), a computer device (e.g., a tablet PC or a laptop), a portable multimedia device, a wearable device, or a combination of one or more of the foregoing devices. A program (e.g., an application) supporting accounting fraud detection according to the present disclosure or any program capable of receiving a report on accounting fraud detection according to the present disclosure may be installed in the user terminal 130. Alternatively, the user terminal 130 may access a web page for supporting accounting fraud detection according to the present disclosure.

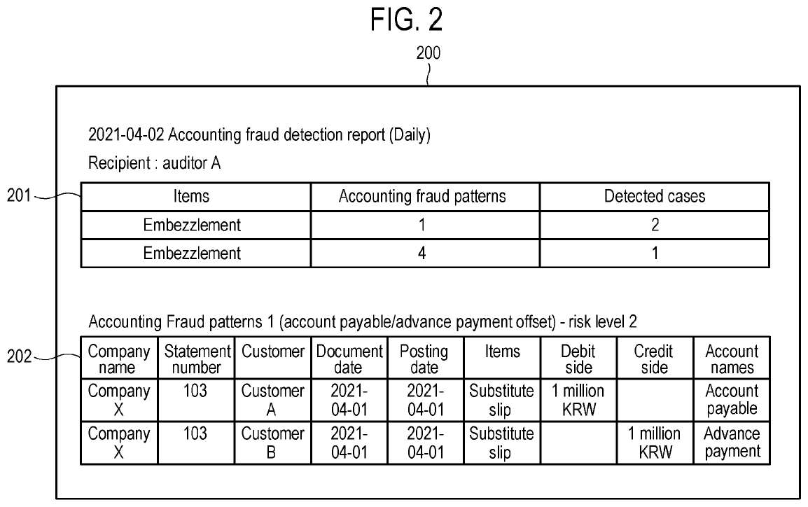

FIG. 2 is a diagram illustrating an exemplary display screen 200 of a user terminal 130 that receives and displays an accounting fraud report according to an embodiment of the present disclosure. As shown in FIG. 2, the accounting fraud report may include a reporting date (“2021 Apr. 2”) and a reporting period (“daily”). In addition, the accounting fraud report may also include a summary of accounting fraud detection items in the form of, for example, a table 201. In addition, the report may include a risk class (“risk level 2”) and data 202 about one or more related statements for the respective accounting detection items. The risk class (“risk level 2”) and the data regarding one or more related statements may be directly included in the report as shown in FIG. 2 or provided as a separate attachment, or an access address thereof may be provided.

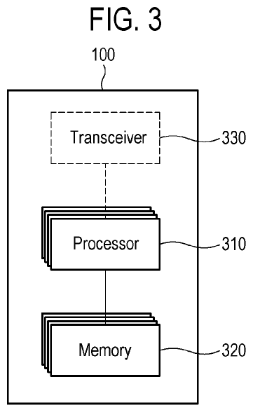

FIG. 3 is a block diagram of a server 100 according to various embodiments of the present disclosure. In an embodiment, the server 100 may include one or more processors 310 and/or one or more memories 320. In an embodiment, at least one of the components of the server 100 may be omitted or other components may be added to the server 100. Additionally or alternatively, some of the components may be implemented as an integrated form or implemented as a single entity or a plurality of entities. At least some of the internal and external components of the server 100 may be connected to each other through a bus, a general purpose input/output (GPIO), a serial peripheral interface (SPI), or a mobile industry processor interface (MIPI) to transmit and receive data and/or signals.

One or more processors 310 may drive software (e.g., commands, programs, etc.) to control at least one component of the server 100 connected to the one or more processors 310. In addition, one or more processors 310 may perform operations such as various calculations, processing, data generation, and processing related to the present disclosure. In addition, one or more processors 310 may load data from one or more memories 320 or store data in one or more memories 320. One or more processors 310 may collect data required for accounting fraud detection from the server 110 of the company to be audited. One or more processors 310 may apply each of a plurality of analyzing functions respectively corresponding to a plurality of accounting fraud patterns to the collected data to determine that a pattern represented by the data matches one accounting fraud pattern among the plurality of accounting fraud patterns. One or more processors 310 may determine a risk class of accounting fraud indicated by the data based at least in part on the collected data. One or more processors 310 may generate warnings against possible accounting fraud on the basis of the collected data.

One or more memories 320 may store a variety of data. Data stored in the memory 320 may be data obtained, processed, or used by at least one component of the server 100 and may include software (e.g., commands, programs, etc.). The memory 320 may include volatile and/or non-volatile memory. In the present disclosure, commands or programs are software stored in the memory 320 and may include an operating system for controlling resources of the server 100, applications, and/or middleware providing various functions to the applications in order for the applications to utilize resources of the server. One or more memories 320 may store commands that cause the one or more processors 310 to perform operations when executed by the one or more processors 310.

In an embodiment, the server 100 may further include a transceiver 330. The transceiver 330 may perform wireless or wired communication between the server 100 and the server 110 of the company to be audited, and between the server 100 and the user terminal 130. For example, the transceiver 330 may perform wireless communication according to a scheme such as eMBB (enhanced mobile broadband), URLLC (ultra-reliable low-latency communications), MMTC (massive machine-type communications), LTE (long-term evolution), LTE-A (LTE advance), UMTS (universal mobile telecommunications system), GSM (global system for mobile communications), CDMA (code division multiple access), WCDMA (wideband CDMA), WiBro (wireless broadband), WiFi (wireless fidelity), Bluetooth, NFC (near field communication), GPS (global positioning system), GNSS (global navigation satellite system), or the like. For example, the transceiver 330 may perform wired communication according to a scheme such as USB (universal serial bus), HDMI (high-definition multimedia interface), RS-232 (recommended standard 232), POTS (plain old telephone service) or the like. In an embodiment, the one or more processors 310 may control the transceiver 330 to communicate with the server 110 of the company to be audited or the user terminal 130. Information received from the server 110 of the company to be audited or the user terminal 130 may be stored in one or more memories 320.

Various embodiments of the server 100 according to the present disclosure may be combined with each other. Respective embodiments may be combined according to the number of cases, and the embodiment of the server 100 made in combination also belongs to the scope of the present disclosure. In addition, the internal/external components of the server 100 according to the present disclosure described above may be added, modified, replaced, or deleted depending on embodiments. In addition, the aforementioned internal/external components of the server 100 may be implemented as hardware components.

The server 110 of the company to be audited may include one or more processors and one or more memories. The one or more memories may store instructions that cause, when executed by the one or more processors, the one or more processors to perform operations. The one or more processors of the server 110 of the company to be audited may perform operations corresponding to the above-described operations of the server 110 of the company to be audited according to the accounting fraud detection technology according to the present disclosure. In an embodiment, the server 110 of the company to be audited may further include a transceiver. The transceiver is the same as described above.

The user terminal 130 may include one or more processors and/or one or more memories. The one or more memories may store instructions that cause, when executed by the one or more processors, the one or more processors to perform operations. The one or more processors of the user terminal 130 may perform operations corresponding to the above-described operations of the server 100 according to the accounting fraud detection technology according to the present disclosure. In an embodiment, the user terminal 130 may further include an input device and/or an output device. The input device is a device for receiving data from a user, and may include, for example, a touch screen, a keyboard, buttons, and the like. The output device is a device that visually provides a variety of data processed by the user terminal 130 to the user, and may include, for example, a touch screen, a display screen, and the like.

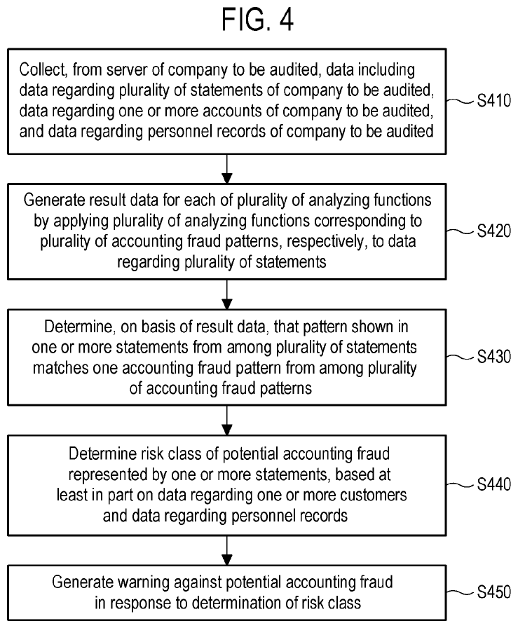

A method for detecting accounting fraud according to the present disclosure may be a computer-implemented method. Hereinafter, although individual steps of the method or algorithm according to the present disclosure are described in sequence in the flowchart of FIG. 4, the individual steps may be performed in an order obtained through any combination according to the present disclosure, in addition to being performed sequentially. The description according to the flowchart of the present disclosure does not exclude changes or modifications to the method or algorithm, and does not indicate that any step is necessary or desirable. In an embodiment, at least some steps may be performed in parallel, iteratively, or heuristically. In an embodiment, at least some steps may be omitted or other steps may be added thereto.

FIG. 4 is a diagram illustrating an embodiment of a method of detecting accounting fraud that may be performed by a server 100 according to the present disclosure. The server 100 according to the present disclosure may perform a method for detecting accounting fraud according to various embodiments of the present disclosure.

In step S410, the one or more processors 310 of the server 100 may collect, from a server 110 of a company to be audited, data including data regarding a plurality of statements of the company to be audited, data regarding one or more customers of the company to be audited, and data regarding personnel records of the company to be audited.

In step S420, the one or more processors 310 may respectively apply data regarding the plurality of statements to a plurality of analyzing functions corresponding to a plurality of accounting fraud patterns to generate result data for each of the plurality of analyzing functions.

In step S430, the one or more processors 310 may determine, based on the result data, that a pattern shown in one or more statements among the plurality of statements matches one accounting fraud pattern among the plurality of accounting fraud patterns.

In step S440, the one or more processors 310, in response to determining that the pattern shown in the one or more statements matches one accounting fraud pattern, may determine a risk class of potential accounting fraud represented by the one or more statements, based at least in part on the data regarding one or more customers and the data regarding personnel records.

In step S450, the one or more processors 310, in response to determination of the risk class, may generate a warning against potential accounting fraud.

Various embodiments of the present disclosure may be implemented as software in a machine-readable storage medium. The software may be software for implementing various embodiments of the present disclosure. The software may be inferred from various embodiments of the present disclosure by programmers skilled in the art to which the present disclosure pertains. For example, software may be a program containing machine-readable instructions (e.g., code or code segments). The machine is an apparatus capable of operating according to instructions called from a storage medium, and may be, for example, a computer. In an embodiment, the machine may be the server 100, the server 110 of a company to be audited, or the user terminal 130 according to embodiments of the present disclosure. In an embodiment, the processor of the machine may execute called instructions such that components of the machine perform functions corresponding to the instructions. In an embodiment, the processor may be the processor 310 of the server 100, the processor of the server 110 of a company to be audited, or the processor of the user terminal 130 according to embodiments of the present disclosure. The storage medium may indicate any type of recording medium capable of storing data and being read by a device. The storage medium may include, for example, a ROM, a RAM, a CD-ROM, a magnetic tape, a floppy disk, an optical data storage, and the like. In an embodiment, the storage medium may be the memory 320 of the server 100, the memory of the server 110 of a company to be audited, or the memory of the user terminal 130. In an embodiment, the storage medium may be implemented in a distributed form in a computer system connected to a network. The software may be distributed, stored, and executed in a computer system or the like. The storage medium may be a non-transitory storage medium. The non-transitory storage medium refers to a tangible medium, regardless of whether data is stored semi-permanently or temporarily, and does not include a temporarily transmitted signal.

Although the technical spirit of the present disclosure has been described by various embodiments, the technical spirit of the present disclosure encompasses various substitutions, modifications, and alterations made within the scope understandable by those skilled in the art to which the present disclosure pertains. In addition, it should be understood that such substitutions, modifications, and alterations are to be included within the scope of the appended claims.

What is claimed is:

1. A server for detecting accounting fraud, the server comprising:
a transceiver;
one or more processors; and
one or more memories configured to store instructions that cause, when executed by the one or more processors, the one or more processors to perform operations,
wherein the operations comprise operations of:
collecting data including data regarding a plurality of statements of a company to be audited, data regarding one or more customers of the company to be audited, and data regarding personnel records of the company to be audited from an external device through the transceiver:
applying the data regarding the plurality of statements to each of a plurality of analyzing functions corresponding to a plurality of accounting fraud patterns to generate result data for each of the plurality of analyzing functions;
determining that a pattern shown in one or more statements among the plurality of statements matches one accounting fraud pattern among the plurality of accounting fraud patterns based on the result data;
in response to determining that the pattern shown in the one or more statements matches the one accounting fraud pattern, determining a risk class of potential accounting fraud represented by the one or more statements, based at least in part on the data regarding one or more customers and the data regarding personnel records; and
generating a warning against the potential accounting fraud in response to determination of the risk class.

2. The server of claim 1, wherein the one or more processors are configured to repeatedly perform the collecting operation in a preset cycle, and
wherein the data regarding the plurality of statements comprises data regarding all statements input to the external device within a preset period of time based on each collection time.

3. The server of claim 2, wherein the operations further comprise operations of:
comparing data regarding the plurality of statements of the company to be audited collected at a first collection time with data regarding the plurality of statements of the company to be audited collected at a second collection time, which is immediately one cycle after the first collection time, to determine that at least a part of the data regarding the plurality of statements of the company to be audited has been modified between the first collection time and the second collection time; and
in response to determining that at least a part of the data regarding the plurality of statements of the company to be audited has been modified between the first collection time and the second collection time, generating a warning against potential accounting fraud according to the modification.

4. The server of claim 1, wherein the operation of generating the result data comprises an operation of applying the data regarding the plurality of statements to each of the plurality of analyzing functions in cycles preset for the respective analyzing functions.

5. The server of claim 1, wherein the operations further comprise an operation of pre-processing the collected data, and
wherein the pre-processing operation comprises operations of:
normalizing the collected data to conform to a preset database format;
normalizing a customer name among the data regarding one or more customers according to a preset rule; and
grouping account titles among the data regarding the plurality of statements.

6. The server of claim 1, wherein the analyzing function corresponding to the one accounting fraud pattern is configured to determine, for one statement, a case to be true if an account title on the debit side is account payable, an account title on the credit side is advance payment, and a customer name on the debit side is different from a customer name on the credit side.

7. The server of claim 1, wherein the plurality of analyzing functions comprises:
one or more analyzing functions of a first type, which are configured to determine, for one statement, a case to be true if an account title on the debit side and an account title on the credit side respectively satisfy preset criteria and one or more pieces of information recorded in the statement satisfy preset criteria;
one or more analyzing functions of a second type, which are configured to determine, for each of two or more statements, a case to be true if an account title on the debit side and an account title on the credit side respectively satisfy preset criteria and one or more pieces of information recorded in the statement satisfy preset criteria;
one or more analyzing functions of a third type, which are configured to determine, for a statement whose posting date satisfies preset criteria, a case to be true if an account title on the debit side and an account title on the credit side respectively satisfy preset criteria and one or more pieces of information recorded in the statement satisfy preset criteria; and
one or more analyzing functions of a fourth type, which are configured to determine a case to be true if a balance of a designated account title does not meet preset criteria for a preset period of time.

8. The server of claim 1, wherein the operation of determining the risk class of potential accounting fraud represented by the one or more statements, based at least in part on the data regarding one or more customers and the data regarding personnel records, comprises operations of:
determining a risk class according to a basic risk level of a matching accounting fraud pattern;
downgrading the risk class if one of exceptional conditions preset for the company to be audited is satisfied;
upgrading the risk class if the data regarding a customer included in the one or more statements satisfies a preset condition for a paper company;
upgrading the risk class if a customer's account holder name included in the one or more statements is not a name of the customer or a representative name thereof;
upgrading the risk class if the data regarding a customer included in the one or more statements at least partially matches the data regarding personnel records;
upgrading the risk class if the data regarding a customer included in the one or more statements is at least partially inconsistent with the data regarding a customer inquired to a credit rating agency, based on a business registration number of the customer; and
upgrading the risk class if a customer included in the one or more statements is newly registered in the external device within a preset period of time.

9. The server of claim 1, wherein the operations further comprise operations of:
generating a report indicating one or more warnings against potential accounting fraud, wherein the one or more warnings occur within a preset period of time and wherein the report comprises, for each of the one or more warnings, a matching accounting fraud pattern, a risk class, and data regarding one or more related statements; and
transmitting the report to one or more user terminals.

10. A method performed in a server for detecting accounting fraud, the method comprising:
collecting data including data regarding a plurality of statements of a company to be audited, data regarding one or more customers of the company to be audited, and data regarding personnel records of the company to be audited from an external device through a transceiver of the server;
applying the data regarding the plurality of statements to each of a plurality of analyzing functions corresponding to a plurality of accounting fraud patterns to generate result data for each of the plurality of analyzing functions;
determining that a pattern shown in one or more statements among the plurality of statements matches one accounting fraud pattern among the plurality of accounting fraud patterns based on the result data;
in response to determining that the pattern shown in the one or more statements matches the one accounting fraud pattern, determining a risk class of potential accounting fraud represented by the one or more statements, based at least in part on the data regarding one or more customers and the data regarding personnel records; and
generating a warning against the potential accounting fraud in response to determination of the risk class.

11. One or more non-transitory computer-readable recording media storing instructions that cause, when executed by one or more processors of a server for detecting accounting fraud, the one or more processors to perform operations, the operations comprise:
collecting data including data regarding a plurality of statements of a company to be audited, data regarding one or more customers of the company to be audited, and data regarding personnel records of the company to be audited from an external device through a transceiver of the server;
applying the data regarding the plurality of statements to each of a plurality of analyzing functions corresponding to a plurality of accounting fraud patterns to generate result data for each of the plurality of analyzing functions;
determining that a pattern shown in one or more statements among the plurality of statements matches one accounting fraud pattern among the plurality of accounting fraud patterns based on the result data;
in response to determining that the pattern shown in the one or more statements matches the one accounting fraud pattern, determining a risk class of potential accounting fraud represented by the one or more statements, based at least in part on the data regarding one or more customers and the data regarding personnel records; and
generating a warning against the potential accounting fraud in response to determination of the risk class.
